(19) United States
(12) Patent Application Publication
(10) Pub. No.: US 2026/0302489 A1
(43) Pub. Date: Oct. 1, 2026

(54) BATTERY DEVICE

(71) Applicants: Hino Motors, Ltd., Tokyo (JP); TOYOTA JIDOSHA KABUSHIKI KAISHA, Toyota-shi (JP)

(72) Inventors: Ryou KOGA, Tokyo (JP); Masashi MATSUI, Tokyo (JP); Gaku HASEGAWA, Tokyo (JP); Tatsuya OHBA, Tokyo (JP)

(73) Assignees: Hino Motors, Ltd., Tokyo (JP); TOYOTA JIDOSHA KABUSHIKI KAISHA, Toyota-shi (JP)

(21) Appl. No.: 19/557,772

(22) Filed: Mar. 5, 2026

(30) Foreign Application Priority Data
Mar. 28, 2025 (JP) 2025-056803

(51) Int. Cl. H01M 50/262; B60K 1/04; H01M 50/249

(52) U.S. Cl. CPC H01M 50/262; H01M 50/249; B60K 1/04; H01M 2220/20

(57) ABSTRACT

A battery device is mounted between a pair of side rails arranged in a vehicle width direction, the battery device comprising: a battery; a holding member that holds the battery; and a first bracket erected on the holding member so as to extend along a vertical direction, wherein the first bracket is disposed between one of the pair of side rails and the battery in the vehicle width direction, and the first bracket has a first main body portion extending along the vertical direction, and a first rib provided on the first main body portion and extending along the vertical direction.

### CROSS-REFERENCE TO RELATED APPLICATIONS

This application is based upon and claims the benefit of priority from Japanese Patent Application No. 2025-056803, filed on Mar. 28, 2025, the entire contents of which are incorporated herein by reference.

### TECHNICAL FIELD

The present disclosure relates to a battery device.

### BACKGROUND

Japanese Unexamined Patent Publication No. 2022-43434 describes a support device for a vehicle battery pack that arranges a battery below a pair of frames of an electric truck. This support device for a vehicle battery pack includes a battery-side bracket that accommodates a battery pack, a frame-side bracket that is disposed on an outer side in a vehicle width direction of a side rail and is connected to the battery-side bracket, and a protruding portion that is disposed on an upper surface of the battery-side bracket and is provided so as to face the side rail. When a physical input is applied to the support device during a vehicle side collision, an amount of movement of the support device in the vehicle width direction is reduced due to contact between the protruding portion and the side rail.

### SUMMARY

There is currently a demand to mount a battery between a pair of side rails. However, in the support device described in the above-mentioned Japanese Unexamined Patent Publication No. 2022-43434, a case of mounting a battery between side rails is not considered. When a battery is mounted between the side rails, at the time of a side collision, the side rail that has received the side collision moves so as to approach the battery, and as a result, there is a risk that the battery and the side rail may interfere with each other.

Therefore, an object of the present disclosure is to provide a battery device capable of suppressing interference between a battery and a side rail during a vehicle side collision.

A battery device according to the present disclosure is [1] “a battery device mounted between a pair of side rails in a vehicle having the pair of side rails arranged in a vehicle width direction, the battery device comprising: a battery; a holding member that holds the battery; and a first bracket and a second bracket erected on the holding member so as to extend along a vertical direction, wherein the first bracket is disposed between one of the pair of side rails and the battery in the vehicle width direction, wherein the first bracket has a first main body portion extending along the vertical direction, and a first rib provided on the first main body portion and extending along the vertical direction, wherein the second bracket is disposed between the other side rail of the pair of side rails and the battery in the vehicle width direction, and wherein the second bracket has a second main body portion extending along the vertical direction, and a second rib provided on the second main body portion and extending along the vertical direction.”

In this battery device, since the battery is mounted between the pair of side rails, there is a risk that the side rail that has received a side collision moves so as to approach the battery at the time of a vehicle side collision. In contrast, in this battery device, brackets (a first bracket and a second bracket) reinforced by ribs (a first rib and a second rib) are erected on the holding member that holds the battery, and the brackets are interposed between the battery and the side rails. As a result, when the side rail that has received a side collision moves so as to approach the battery at the time of a vehicle side collision, by causing the side rail and the bracket to interfere with each other, a distance between the battery and the side rail is secured, and interference between the battery and the side rail is suppressed.

The battery device according to the present disclosure may be [2] “the battery device according to [1], wherein the holding member includes a first holding member and a second holding member disposed on the first holding member, the battery includes a first battery held by the first holding member, and a second battery disposed on the first battery by being held by the second holding member, and the first bracket and the second bracket are bridged between the first holding member and the second holding member and fix the first holding member and the second holding member to each other.” In this way, the holding members and the batteries may be stacked vertically by utilizing the first bracket and the second bracket having a function of suppressing interference between the battery and the side rails.

The battery device according to the present disclosure may be [3] “the battery device according to [2], wherein the first bracket has a first fixing portion that extends from a lower end portion of the first main body portion along the vehicle width direction and is fixed to the first holding member, and the first rib is provided only on the first main body portion and has a rectangular shape when viewed from a front-rear direction.” In this case, simplification of the structure and facilitation of manufacturing are achieved.

The battery device according to the present disclosure may be “the battery device according to [2], wherein the first bracket has a first fixing portion that extends from a lower end portion of the first main body portion along the vehicle width direction and is fixed to the first holding member, and the first rib is provided so as to extend from the first main body portion to the first fixing portion and has an L-shape when viewed from a front-rear direction.” In this case, the first bracket can be reliably reinforced.

The battery device according to the present disclosure may be [5]0 “the battery device according to any one of [1] to [4], wherein each of the pair of side rails has a main body portion facing the battery, and a flange extending from the main body portion toward the battery, and the first rib and the second rib extend along the vertical direction so as to straddle the respective flanges.” In this case, when the side rail that has received a side collision moves so as to approach the battery at the time of a vehicle side collision, the flange of the side rail can be reliably made to interfere with the first rib or the second rib. As a result, even in a case where the side rail has a flange, interference between the side rail and the battery can be suppressed.

According to the present disclosure, it is possible to provide a battery device capable of suppressing interference between a battery and a side rail during a vehicle side collision.

### BRIEF DESCRIPTION OF THE DRAWINGS

FIG. 1 is a perspective view illustrating a part of a vehicle provided with a battery device according to the present embodiment.

FIG. 2 is a perspective view illustrating the battery device.

FIG. 3 is another perspective view illustrating the battery device.

FIG. 4 is an exploded perspective view of a first holding member, a second holding member, a first bracket, and a second bracket.

FIG. 5 is a cross-sectional view taken along line V-V in FIG. 1.

FIG. 6 is a plan view illustrating the vehicle.

FIG. 7 is a perspective view illustrating the first bracket.

FIG. 8 is a diagram for explaining a method of mounting the battery device on the vehicle.

FIGS. 9A, 9B, and 9C are cross-sectional views of the vehicle for explaining the movement of the battery device and the pair of side rails during a vehicle side collision.

FIG. 10 is a perspective view illustrating a first bracket according to a modification.

### DETAILED DESCRIPTION

Hereinafter, a battery device according to an embodiment will be described with reference to the drawings. In the description of each drawing, the same or corresponding elements are denoted by the same reference numerals, and redundant description may be omitted.

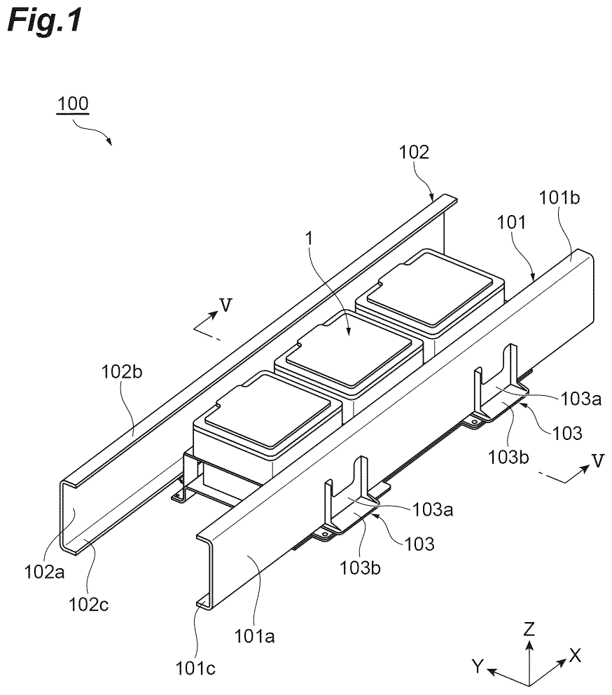

FIG. 1 is a perspective view illustrating a part of a vehicle provided with a battery device according to the present embodiment. A battery device 1 according to the present embodiment is mounted on a vehicle 100. The vehicle 100 is, for example, a large vehicle such as a truck, a freight vehicle, or a bus vehicle. The vehicle 100 is, for example, an electrified vehicle. The electrified vehicle is, for example, a hybrid electric vehicle (HEV), a plug-in hybrid electric vehicle (PHEV), a fuel cell electric vehicle (FCEV), a battery electric vehicle (BEV), or the like.

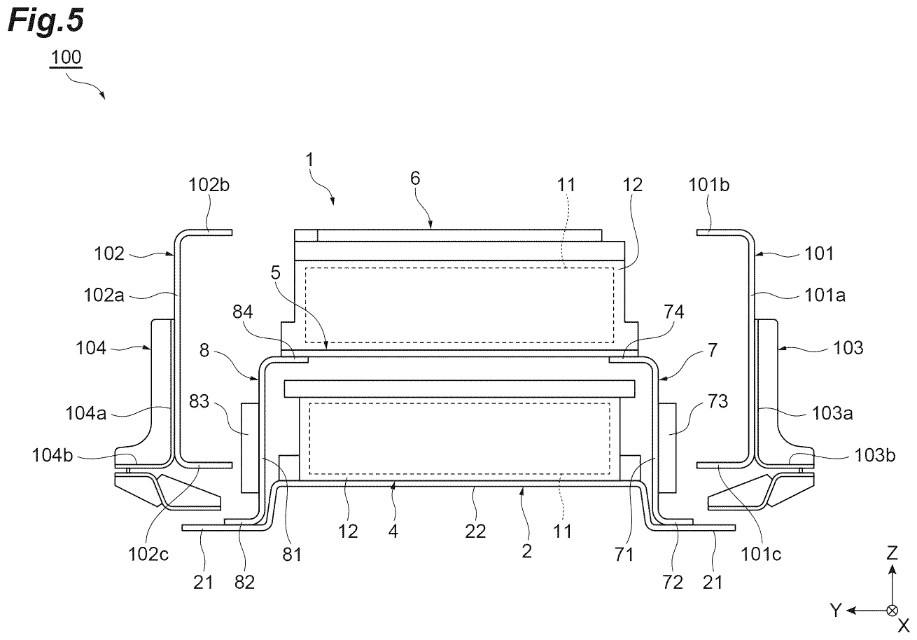

The vehicle 100 includes the battery device 1, a pair of side rails 101 and 102, and a plurality of brackets 103 and 104 (see FIG. 5). The side rail 101 and the side rail 102 are arranged in a vehicle width direction Y and extend in a front-rear direction X. In this specification, a forward direction and a backward direction of the vehicle 100 are referred to as a front-rear direction X of the vehicle 100, and a left-right direction when the vehicle 100 is viewed from the rear, which intersects (for example, is orthogonal to) the front-rear direction X, is referred to as a vehicle width direction Y. In addition, a direction perpendicular to the front-rear direction X and the vehicle width direction Y is referred to as a vertical direction Z.

The battery device 1 is used, for example, for driving an electrified vehicle, and has a plurality of batteries that are integrally held. The battery device 1 is mounted between the side rail 101 and the side rail 102.

The side rail 101 has a main body portion 101a, an upper flange 101b, and a lower flange 101c. The main body portion 101a faces the battery device 1 (a first battery 4 and a second battery 6, which will be described later). The upper flange 101b extends from an upper end of the main body portion 101a toward the battery device 1 (the second battery 6). The lower flange 101c extends from a lower end of the main body portion 101a toward the battery device 1 (the first battery 4). As a result, the side rail 101 is formed in a U-shape having an opening on the battery device 1 side in a cross section that intersects the front-rear direction X.

Here, the side rail 102 has a main body portion 102a, an upper flange 102b, and a lower flange 102c. The main body portion 102a faces the battery device 1 (the first battery 4 and the second battery 6). The upper flange 102b extends from an upper end of the main body portion 102a toward the battery device 1 (the second battery 6). The lower flange 102c extends from a lower end of the main body portion 102a toward the battery device 1 (the first battery 4). As a result, the side rail 102 is formed in a U-shape having an opening on the battery device 1 side in a cross section that intersects the front-rear direction X.

The brackets 103 and 104 are for attaching the battery device 1 to the side rails 101 and 102. In the present embodiment, a pair of brackets 103 are disposed on an outer side in the vehicle width direction Y of the side rail 101 at positions separated from each other in the front-rear direction X, and a pair of brackets 104 are disposed on an outer side in the vehicle width direction Y of the side rail 102 at positions separated from each other in the front-rear direction X.

The bracket 103 is formed in an L-shape when viewed from the front-rear direction X by a first portion 103a extending along the vertical direction Z and a second portion 103b extending outward in the vehicle width direction Y from a lower end of the first portion 103a. The bracket 103 fixes the battery device 1 to the side rail 101 by being connected at the first portion 103a to a surface of the main body portion 101a of the side rail 101 that faces outward in the vehicle width direction Y and being connected at the second portion 103b to a holding member (a first holding member 2) of the battery device 1, which will be described later.

Similarly, the bracket 104 is formed in an L-shape when viewed from the front-rear direction X by a first portion 104a (see FIG. 5) extending along the vertical direction Z and a second portion 104b (see FIG. 5) extending outward in the vehicle width direction Y from a lower end of the first portion 104a. The bracket 104 fixes the battery device 1 to the side rail 102 by being connected at the first portion 104a to a surface of the main body portion 102a of the side rail 102 that faces outward in the vehicle width direction Y, and being connected at the second portion 104b to the holding member (the first holding member 2) of the battery device 1.

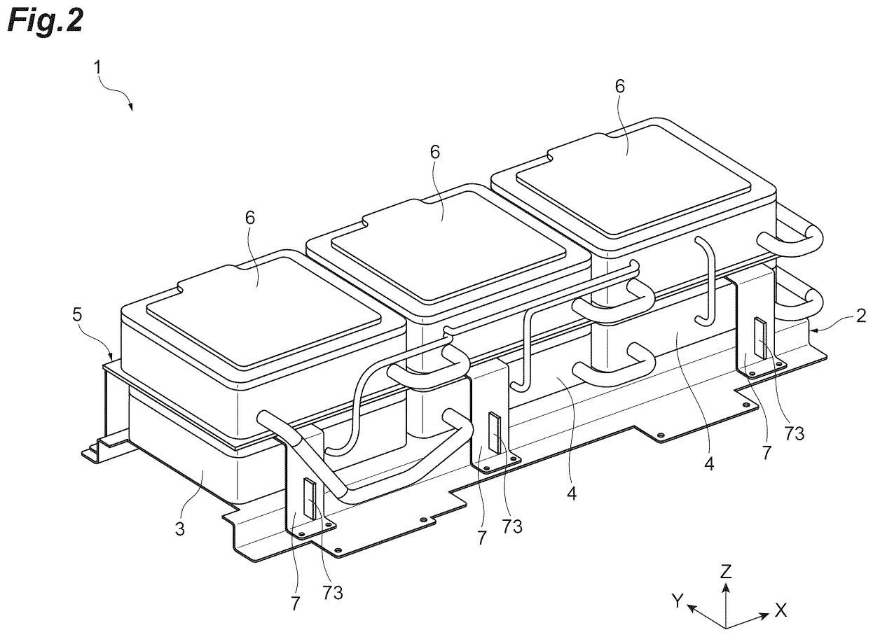

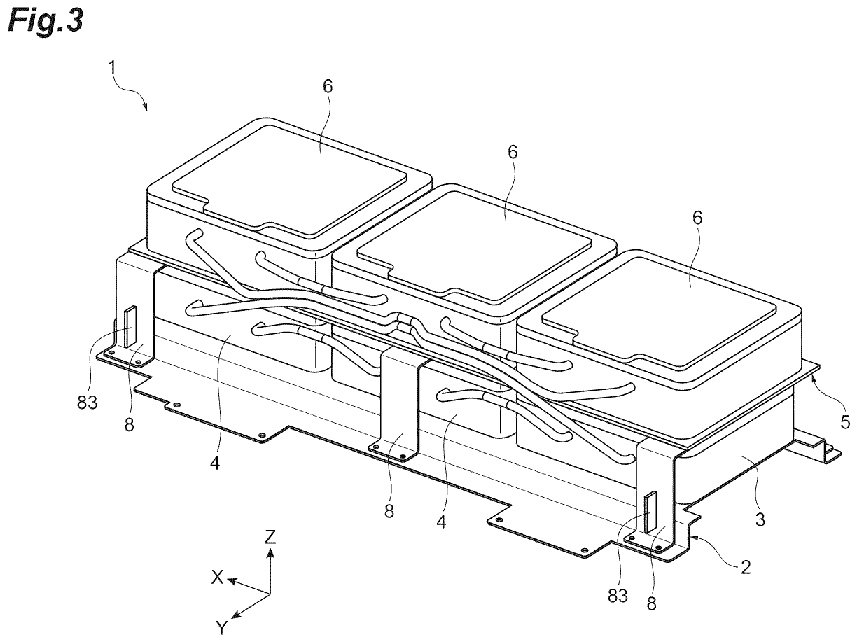

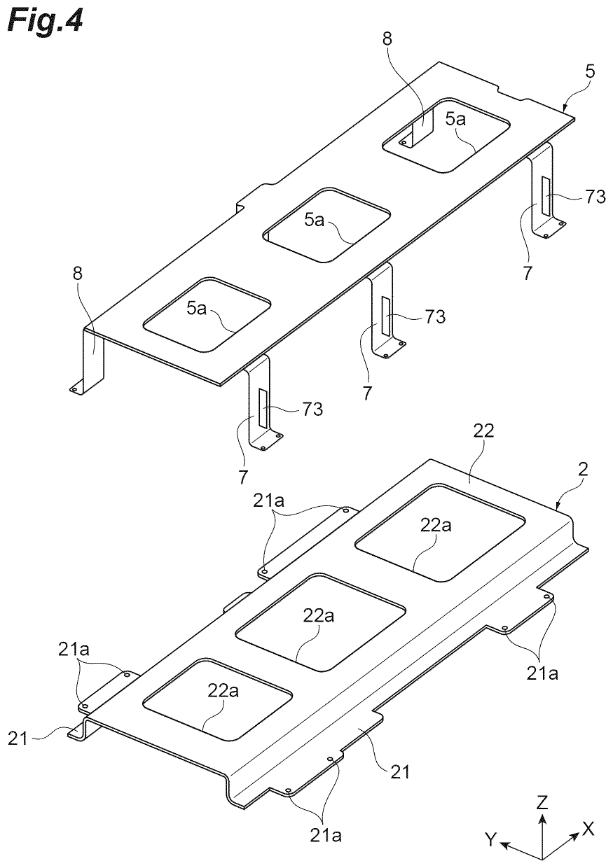

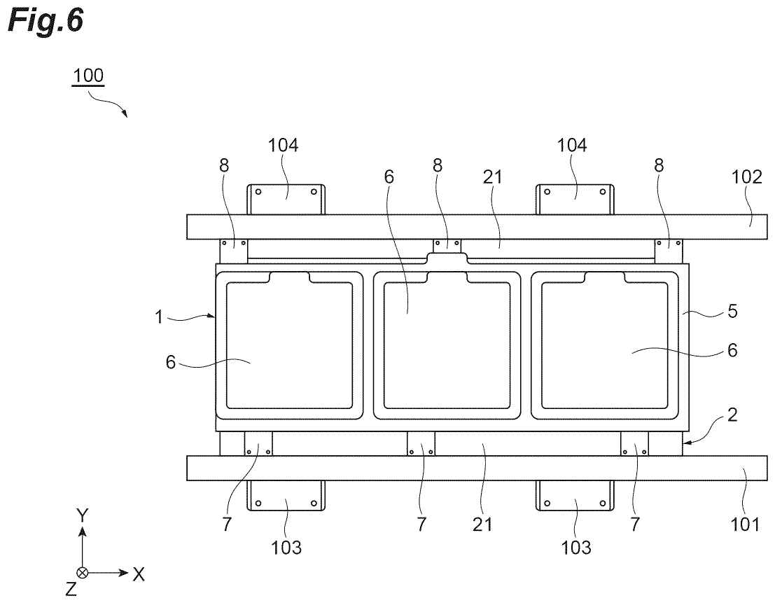

FIG. 2 is a perspective view illustrating the battery device 1. FIG. 3 is another perspective view illustrating the battery device 1. FIG. 4 is an exploded perspective view of the first holding member 2, the second holding member 5, the first bracket 7, and the second bracket 8. FIG. 5 is a cross-sectional view taken along line V-V in FIG. 1. FIG. 6 is a plan view illustrating the vehicle 100. As illustrated in FIGS. 2 to 6, the battery device 1 includes a first holding member (holding member) 2, an electrical component box 3, a plurality of (two in this case) first batteries (batteries) 4, a second holding member (holding member) 5, a plurality of (three in this case) second batteries 6, a plurality of (three in this case) first brackets (brackets) 7, and a plurality of (three in this case) second brackets 8.

The first battery 4 and the second battery 6 each have, for example, a plurality of electrodes 11 stacked on each other and a case 12 that accommodates the plurality of electrodes 11. As an example, each of the first batteries 4 and each of the second batteries 6 have the same electric capacity as each other, which is less than the electric capacity required for the vehicle 100. Here, the first battery 4 and the second battery 6 are the same batteries. The plurality of first batteries 4 and the plurality of second batteries 6 are, for example, connected in series with each other. The electrical component box 3 is electrically connected to the first battery 4 and the second battery 6. The electrical component box 3 has the same outer shape as the first battery 4 and the second battery 6.

That is, in the present embodiment, the first battery 4, the second battery 6, and the electrical component box 3 are all formed in a similar rectangular parallelepiped shape. The first holding member 2 holds and integrates one electrical component box 3 and two first batteries 4 arranged along the front-rear direction X. The electrical component box 3 is located in front of the two first batteries 4. The length of the first holding member 2 in the front-rear direction X is longer than the length of the first holding member 2 in the vehicle width direction Y. In a cross section intersecting the front-rear direction X, the shape of the first holding member 2 is a hat shape that is open downward.

More specifically, the first holding member 2 has a pair of attachment portions 21 located at both ends in the vehicle width direction Y, and a placement portion 22 located between the pair of attachment portions 21. The attachment portions 21 and the placement portion 22 are plate-shaped. The placement portion 22 is located above the attachment portions 21 and is connected to the attachment portions 21 by portions extending perpendicularly to the placement portion 22 and the attachment portions 21. The placement portion 22 is provided with a plurality of openings 22a (three as an example) facing a lower surface of the electrical component box 3 and lower surfaces of the two first batteries 4. The openings 22a are rectangular. The attachment portion 21 is provided with a plurality of fastening holes 21a for inserting bolts for fastening the brackets 103 and 104 and the first holding member 2.

The second holding member 5 holds the second batteries 6. The second holding member 5 holds and integrates three second batteries 6 arranged along the front-rear direction X. The second holding member 5 is disposed on the first holding member 2 and is fixed to the first holding member 2 by the first bracket 7 and the second bracket 8 as will be described later. The second holding member 5 is separated from the first holding member 2, and the electrical component box 3 and the first batteries 4 are disposed between the first holding member 2 and the second holding member 5. The second holding member 5 is not in contact with the electrical component box 3 and the first batteries 4. The second batteries 6 are disposed on the first batteries 4 by being held by the second holding member 5 in a state of being placed on the second holding member 5.

The second holding member 5 is plate-shaped. A length of the second holding member 5 in the front-rear direction X is, for example, substantially equal to the length of the first holding member 2 in the front-rear direction X. A length of the second holding member 5 in the vehicle width direction Y is shorter than the length of the first holding member 2 in the vehicle width direction Y. The second holding member 5 is provided with a plurality of openings 5a (three as an example) facing lower surfaces of the three second batteries 6. The openings 5a are rectangular.

The first brackets 7 are erected on the first holding member 2. More specifically, the first brackets 7 are erected on the attachment portion 21 on one side in the vehicle width direction Y of the first holding member 2. Each first bracket 7 extends upward in a state where one end thereof is fixed to the first holding member 2, and the other end thereof is fixed to the second holding member 5. As a result, the first brackets 7 are bridged between the first holding member 2 and the second holding member 5, and fix the first holding member 2 and the second holding member 5 to each other. The first brackets 7 are disposed between the side rail 101 and the battery device 1 (the first battery 4) in the vehicle width direction Y. The first brackets 7 are made of, for example, iron. Details of the first bracket 7 will be described later.

The second brackets 8 are erected on the first holding member 2. More specifically, the second brackets 8 are erected on the attachment portion 21 on the other side in the vehicle width direction Y of the first holding member 2. Each second bracket 8 extends upward in a state where one end thereof is fixed to the first holding member 2, and the other end thereof is fixed to the second holding member 5. As a result, the second brackets 8 are bridged between the first holding member 2 and the second holding member 5, and fix the first holding member 2 and the second holding member 5 to each other. The second brackets 8 are disposed between the side rail 102 and the battery device 1 (the first battery 4) in the vehicle width direction Y. The second brackets 8 are made of, for example, iron. Details of the second bracket 8 will be described later.

Three first brackets 7 and three second brackets 8 are erected on the first holding member 2. More specifically, the three first brackets 7 and the three second brackets 8 are respectively arranged along the front-rear direction X. As an example, the second bracket 8 located at the most forward position among the three second brackets 8 is located more forward than the first bracket 7 located at the most forward position among the three first brackets 7. The second bracket 8 located at the most rearward position among the three second brackets 8 is located more rearward than the first bracket 7 located at the most rearward position among the three first brackets 7.

That is, the three first brackets 7 are disposed between the foremost second bracket 8 and the rearmost second bracket 8 when viewed from the vehicle width direction Y. Among the three second brackets 8, the second bracket 8 located in the middle in the front-rear direction X is located more rearward than the first bracket 7 located in the middle in the front-rear direction X among the three first brackets 7.

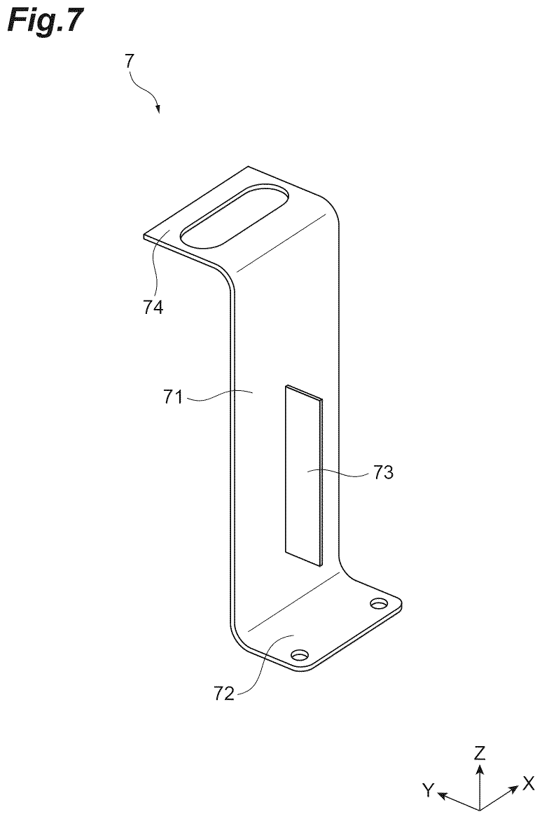

Next, the first bracket 7 and the second bracket 8 will be described in detail with reference to FIGS. 5 and 7. FIG. 7 is a perspective view illustrating the first bracket 7. The first bracket 7 has a first main body portion 71, a first fixing portion 72, a first rib 73, and a first placement portion 74. The first main body portion 71 extends along the vertical direction Z. The first main body portion 71 faces the first battery 4. The first main body portion 71 is in the shape of a rectangular flat plate.

The first fixing portion 72 extends from a lower end portion of the first main body portion 71 along the vehicle width direction Y. The first fixing portion 72 is located on an outer side with respect to the first main body portion 71 in the vehicle width direction Y. The first fixing portion 72 is in the shape of a rectangular flat plate. A length of the first fixing portion 72 in the front-rear direction X is equal to a length of the first main body portion 71 in the front-rear direction X. The first fixing portion 72 is fixed to the first holding member 2. The first fixing portion 72 is provided with two fastening holes that penetrate the first fixing portion 72 in the vertical direction Z. The first fixing portion 72 is fastened to the first holding member 2 with two bolts in a state where shafts of the bolts are inserted into the fastening holes.

The first placement portion 74 extends from an upper end portion of the first main body portion 71 along the vehicle width direction Y. A direction in which the first placement portion 74 extends is opposite to a direction in which the first fixing portion 72 extends. That is, the first placement portion 74 is located on an inner side with respect to the first main body portion 71 in the vehicle width direction Y. The first placement portion 74 is in the shape of a rectangular flat plate. A length of the first placement portion 74 in the front-rear direction X is equal to the length of the first main body portion 71 in the front-rear direction X. The second holding member 5 is placed and fixed on the first placement portion 74. The first placement portion 74 is provided with a fastening hole (that is, an elongated hole extending in the front-rear direction X) whose length in the front-rear direction X is longer than its length in the vehicle width direction Y. The first placement portion 74 is fastened to the second holding member 5 with a bolt in a state where a shaft of the bolt is inserted into the fastening hole. The first bracket 7 has a Z-shape when viewed from the front-rear direction X because the first fixing portion 72, the first main body portion 71, and the first placement portion 74 are integrally formed.

The first rib 73 reinforces the first bracket 7. The first rib 73 is provided only on the first main body portion 71. That is, the first rib 73 is not in contact with the first fixing portion 72 and the first placement portion 74. The first rib 73 extends along the vertical direction Z. The first rib 73 is formed in a rectangular parallelepiped shape presenting a rectangular shape when viewed from the front-rear direction X. The first rib 73 extends along the vertical direction Z so as to straddle the lower flange 101c of the side rail 101. That is, the first rib 73 has a portion that overlaps with the lower flange 101c of the side rail 101 when viewed from the vehicle width direction Y. The first rib 73 described above is made of, for example, iron, and is joined to the first bracket 7 by, for example, welding. In this way, the first bracket 7, in a state of being reinforced by the first rib 73, is interposed between the first battery 4 and the side rail 101.

The second bracket 8 has a second main body portion 81, a second fixing portion 82, a second rib 83, and a second placement portion 84. The second main body portion 81 extends along the vertical direction Z. The second main body portion 81 faces the first battery 4. The second main body portion 81 is in the shape of a rectangular flat plate.

The second fixing portion 82 extends from a lower end portion of the second main body portion 81 along the vehicle width direction Y. The second fixing portion 82 is located on an outer side with respect to the second main body portion 81 in the vehicle width direction Y. The second fixing portion 82 is in the shape of a rectangular flat plate. A length of the second fixing portion 82 in the front-rear direction X is equal to a length of the second main body portion 81 in the front-rear direction X. The second fixing portion 82 is fixed to the first holding member 2. The second fixing portion 82 is provided with two fastening holes that penetrate the second fixing portion 82 in the vertical direction Z. The second fixing portion 82 is fastened to the first holding member 2 with two bolts in a state where shafts of the bolts are inserted into the fastening holes.

The second placement portion 84 extends from an upper end portion of the second main body portion 81 along the vehicle width direction Y. A direction in which the second placement portion 84 extends is opposite to a direction in which the second fixing portion 82 extends. That is, the second placement portion 84 is located on an inner side with respect to the second main body portion 81 in the vehicle width direction Y. The second placement portion 84 is in the shape of a rectangular flat plate. A length of the second placement portion 84 in the front-rear direction X is equal to the length of the second main body portion 81 in the front-rear direction X. The second holding member 5 is placed and fixed on the second placement portion 84. The second placement portion 84 is provided with a fastening hole (that is, an elongated hole extending in the front-rear direction X) whose length in the front-rear direction X is longer than its length in the vehicle width direction Y. The second placement portion 84 is fastened to the second holding member 5 with a bolt in a state where a shaft of the bolt is inserted into the fastening hole. The second bracket 8 has a Z-shape when viewed from the front-rear direction X because the second fixing portion 82, the second main body portion 81, and the second placement portion 84 are integrally formed.

The second rib 83 reinforces the second bracket 8. The second rib 83 is provided only on the second main body portion 81. That is, the second rib 83 is not in contact with the second fixing portion 82 and the second placement portion 84. The second rib 83 extends along the vertical direction Z. The second rib 83 is formed in a rectangular parallelepiped shape presenting a rectangular shape when viewed from the front-rear direction X. The second rib 83 extends along the vertical direction Z so as to straddle the lower flange 102c of the side rail 102. That is, the second rib 83 has a portion that overlaps with the lower flange 102c of the side rail 102 when viewed from the vehicle width direction Y. The second rib 83 described above is made of, for example, iron, and is joined to the second bracket 8 by, for example, welding. In this way, the second bracket 8, in a state of being reinforced by the second rib 83, is interposed between the first battery 4 and the side rail 102.

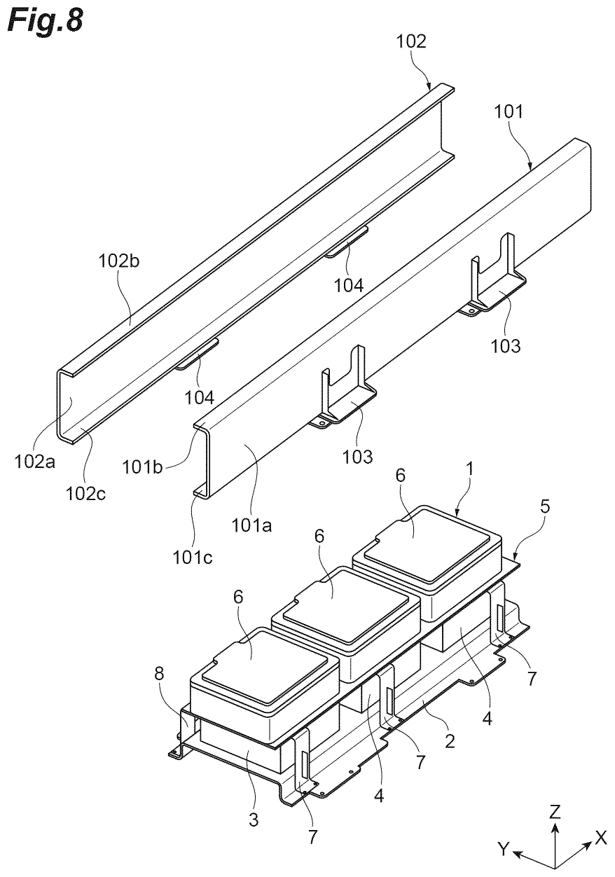

Next, a method of mounting the battery device 1 on the vehicle 100 will be described with reference to FIG. 8. FIG. 8 is a diagram for explaining a method of mounting the battery device 1 on the vehicle 100. First, the brackets 103 and 104 are fixed to the main body portion 101a of the side rail 101 and the main body portion 102a of the side rail 102, respectively. Next, the battery device 1 is placed between the side rail 101 and the side rail 102 from below the side rails 101 and 102. Subsequently, each of the brackets 103 and 104 is fastened to the first holding member 2 with bolts.

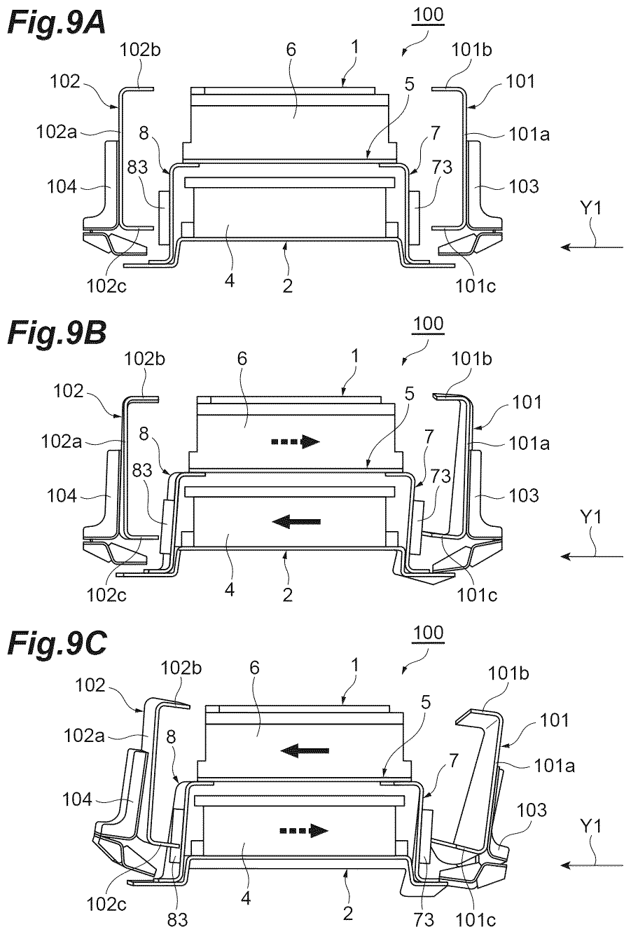

Next, the operation and effects of the battery device 1 will be described with reference to FIGS. 9A, 9B, and 9C. FIGS. 9A, 9B, and 9C are cross-sectional views of the vehicle 100 for explaining the movement of the battery device 1 and the side rails 101 and 102 during a vehicle side collision. Hereinafter, a case where a test cart collides with the side rail 101 will be described as a vehicle side collision. For convenience of explanation, a direction from the side rail 101 toward the side rail 102 along the vehicle width direction Y is referred to as a direction Y1. FIG. 9A illustrates a moment when a vehicle side collision occurs, FIG. 9B illustrates a state after a first time (for example, about 47.5 msec) has elapsed since the vehicle side collision occurred, and FIG. 9C illustrates a state after a second time (a time longer than the first time, for example, about 97.5 msec) has elapsed since the vehicle side collision occurred.

First, in the state of FIG. 9A, the battery device 1 and the side rails 101 and 102 are stationary with respect to each other. Next, in the state of FIG. 9B, the side rail 101 is pushed in a direction Y1 (inward in the vehicle width direction Y) due to the collision of the test cart. At this time, the lower flange 101c of the side rail 101 comes into contact with the first rib 73 of the first bracket 7. As a result, the pushing-in of the lower flange 101c is stopped, and a gap is maintained between the lower flange 101c and the first battery 4. As a result, at this point in time, interference between the side rail 101 and the first battery 4 is suppressed. Along with this, as the first bracket 7, the first holding member 2, the first battery 4, and the second bracket 8 try to move integrally in the direction Y1, a relative acceleration is generated between the first battery 4 and the second battery 6.

Thereafter, as illustrated in FIG. 9C, while the second battery 6 tries to move in the direction Y1 due to a swing-back, the second rib 83 of the second bracket 8 comes into contact with the lower flange 102c of the side rail 102, so that the movement of the first battery 4 and the second bracket 8 is stopped, and as a result, a gap is maintained between the lower flange 102c and the first battery 4, and between the upper flange 102b and the second battery 6. As a result, interference between the side rail 102 and the first battery 4 and the second battery 6 is suppressed.

As described above, in the battery device 1 according to the present embodiment, since the first battery 4 and the second battery 6 are mounted between the pair of side rails 101 and 102, there is a risk that the side rail that has received a side collision moves so as to approach the first battery 4 and the second battery 6 at the time of a vehicle side collision. In contrast, in the battery device 1, brackets (the first bracket 7 and the second bracket 8) reinforced by ribs (the first rib 73 and the second rib 83) are erected on the first holding member 2 that holds the first battery 4, and the first bracket 7 and the second bracket 8 are interposed between the first battery 4 and the side rails 101 and 102. As a result, when the side rails 101 and 102 that have received a side collision move so as to approach the first battery 4 at the time of a vehicle side collision, by causing the side rail 101 and the first bracket 7 to interfere with each other, and by causing the side rail 102 and the second bracket 8 to interfere with each other, a distance between the first battery 4 and the side rails 101 and 102 is secured, and interference between the first battery 4 and the side rails 101 and 102 is suppressed. By a similar effect, interference between the electrical component box 3 and the second battery 6 and the side rails 101 and 102 is suppressed.

The first bracket 7 and the second bracket 8 are bridged between the first holding member 2 and the second holding member 5, and fix the first holding member 2 and the second holding member 5 to each other. In this way, by utilizing the first bracket 7 and the second bracket 8 having a function of suppressing interference between the first battery 4 and the side rails 101 and 102, the first holding member 2 and the second holding member 5 can be stacked vertically, and the first battery 4 and the second battery 6 can be stacked vertically.

The first bracket 7 has a first fixing portion 72 that extends from a lower end portion of the first main body portion 71 along the vehicle width direction Y and is fixed to the first holding member 2, and the first rib 73 is provided only on the first main body portion 71, whereby it is formed in a rectangular shape when viewed from the front-rear direction X. As a result, simplification of the structure and facilitation of manufacturing are achieved.

The side rail 101 has a main body portion 101a that faces the first battery 4, and a lower flange 101c that extends from the main body portion 101a toward the first battery 4. The side rail 102 has a main body portion 102a that faces the first battery 4, and a lower flange 102c that extends from the main body portion 102a toward the first battery 4. The first rib 73 extends along the vertical direction Z so as to straddle the lower flange 101c, and the second rib 83 extends along the vertical direction Z so as to straddle the lower flange 102c. As a result, when the side rails 101 and 102 that have received a side collision move so as to approach the first battery 4 at the time of a vehicle side collision, the lower flange 101c of the side rail 101 can be reliably made to interfere with the first rib 73, and the lower flange 102c of the side rail 102 can be reliably made to interfere with the second rib 83. As a result, even in a case where the side rails 101 and 102 have the lower flanges 101c and 102c, interference of the side rails 101 and 102 with the first battery 4 can be suppressed.

The embodiment described above explains one aspect of the battery device according to the present disclosure. Therefore, the battery device according to the present disclosure is not limited to the battery device 1 according to the above-described embodiment, and can be arbitrarily modified.

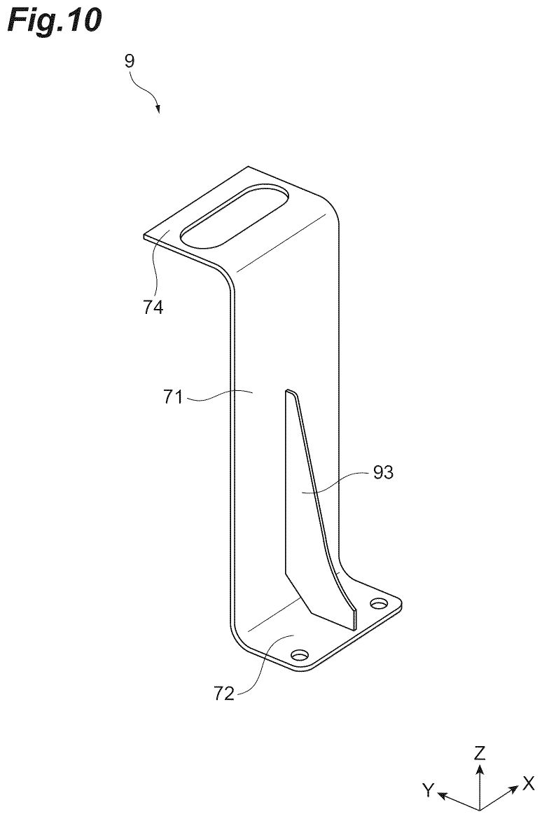

A battery device according to a modification may have a first bracket 9 instead of the first bracket 7. FIG. 10 is a perspective view illustrating the first bracket 9. The first bracket 9 mainly differs from the first bracket 7 in that it has a first rib 93 instead of the first rib 73.

The first rib 93 of the first bracket 9 is provided so as to extend from the first main body portion 71 to the first fixing portion 72. The first rib 93 is formed in an L-shape when viewed from the front-rear direction X. A length of the first rib 93 in the vehicle width direction Y becomes longer as it approaches the first fixing portion 72 in the vertical direction Z. However, the first rib 93 may be composed of a rectangular plate-shaped portion connected to the first main body portion 71 and extending along the vertical direction Z, and a rectangular plate-shaped portion connected to the first fixing portion 72 and extending along the vehicle width direction Y. According to this, the first bracket 9 can be reliably reinforced.

Similarly, a battery device according to a modification may have a second bracket having the same configuration as the first bracket 9 instead of the second bracket 8.

Furthermore, the battery device 1 is not limited to a case where it includes a plurality of batteries stacked vertically, such as the first battery 4 and the second battery 6. That is, in the battery device 1, the battery may be composed of a plurality of first batteries 4 (or second batteries 6), or may be a single first battery 4 (or second battery 6). In these cases, the holding member may be only the first holding member 2 (or the second holding member 5).

What is claimed is:

1. A battery device mounted between a pair of side rails in a vehicle having the pair of side rails arranged in a vehicle width direction, the battery device comprising:
a battery;
a holding member that holds the battery; and
a first bracket and a second bracket erected on the holding member so as to extend along a vertical direction,
wherein the first bracket is disposed between one of the pair of side rails and the battery in the vehicle width direction,
wherein the first bracket has a first main body portion extending along the vertical direction, and a first rib provided on the first main body portion and extending along the vertical direction,
wherein the second bracket is disposed between the other side rail of the pair of side rails and the battery in the vehicle width direction, and
wherein the second bracket has a second main body portion extending along the vertical direction, and a second rib provided on the second main body portion and extending along the vertical direction.

2. The battery device according to claim 1, wherein the holding member includes a first holding member and a second holding member disposed on the first holding member,
wherein the battery includes a first battery held by the first holding member, and a second battery disposed on the first battery by being held by the second holding member, and
wherein the first bracket and the second bracket are bridged between the first holding member and the second holding member and fix the first holding member and the second holding member to each other.

3. The battery device according to claim 2, wherein the first bracket has a first fixing portion that extends from a lower end portion of the first main body portion along the vehicle width direction and is fixed to the first holding member, and
wherein the first rib is provided only on the first main body portion and has a rectangular shape when viewed from a front-rear direction.

4. The battery device according to claim 2, wherein the first bracket has a first fixing portion that extends from a lower end portion of the first main body portion along the vehicle width direction and is fixed to the first holding member, and
wherein the first rib is provided so as to extend from the first main body portion to the first fixing portion and has an L-shape when viewed from a front-rear direction.

5. The battery device according to claim 1, wherein each of the pair of side rails has a main body portion facing the battery, and a flange extending from the main body portion toward the battery, and
wherein the first rib and the second rib extend along the vertical direction so as to straddle the respective flanges.
